(19) United States
(12) Patent Application Publication
(10) Pub. No.: US 2008/0162766 A1
(43) Pub. Date: Jul. 3, 2008

(54) SIGNAL TECHNIQUES FOR BUS INTERFACES

(76) Inventors: Blaise Fanning, Folsom, CA (US); Chris Matthews, Folsom, CA (US); Chunyu Zhang, Folsom, CA (US)

Correspondence Address: KACVINSKY LLC;C/O INTELLEVATE, P.O. BOX 52050, MINNEAPOLIS, MN, 55402, US

(21) Appl. No.: 11/618,509

(22) Filed: Dec. 29, 2006

(51) Int. Cl. G06F 13/14

(52) U.S. Cl. 710/305

(57) ABSTRACT

Techniques involving the transfer of signals across interconnection media are disclosed. For instance, an apparatus may include a configuration module and a driver module. The configuration module establishes an operational mode setting from a first operational mode and a second operational mode. The driver module may operate according to this setting. For instance, according to the first operational mode, the driver module continually drives an interconnection medium. However, for the second operational mode, the driver module drives the interconnection medium when it receives an input signal and otherwise refrains from driving the interconnection medium. According to the first operational mode, a termination module may couple a pull-up resistance to the interconnection medium. However, for the second operational mode, the termination module does not couple such a resistance to the interconnection medium.

### BACKGROUND

Many devices include multiple electronic components that exchange information with each other. Such information may be exchanged across interconnection media in the form of electrical signals. For example, interfaces known generally as buses may distribute information between components of a computer.

Certain signaling protocols may impose certain requirements for transmitting or driving electrical signals across a medium. Such requirements are often aimed at ensuring certain performance capabilities. For example, signaling protocols may impose requirements to ensure that a bus interface may provide for connectivity across a particular maximum distance. For certain devices, however, such performance capabilities may not be desirable.

### BRIEF DESCRIPTION OF THE DRAWINGS

FIGS. 1A and 1B illustrate apparatus embodiments.

FIG. 2 illustrates a further apparatus embodiment.

FIG. 3 illustrates one embodiment of a logic diagram.

FIG. 4 illustrates an exemplary system.

### DETAILED DESCRIPTION

Various embodiments may be generally directed to techniques involving the transfer of signals across interconnection media. For instance, in embodiments, an apparatus may include a configuration module and a driver module. The configuration module determines one of a first operational mode and a second operational mode. The driver module may operate according to this selection. For instance, when the first operational mode is selected, the driver module continually drives an interconnection medium. However, when the second operational mode is selected, the driver module drives the interconnection medium when it receives an input signal and otherwise refrains from driving the interconnection medium.

The apparatus may further include a termination module having a pull-up resistance. When the first operational mode is selected, the pull-up resistance is coupled to the interconnection medium. However, when the second operational mode is selected, the pull-up resistance is isolated from the interconnection medium.

As described herein, embodiments may advantageously provide for reduced power consumption. In addition, embodiments may provide for reduced heat dissipation.

Embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include other combinations of elements in alternate arrangements as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

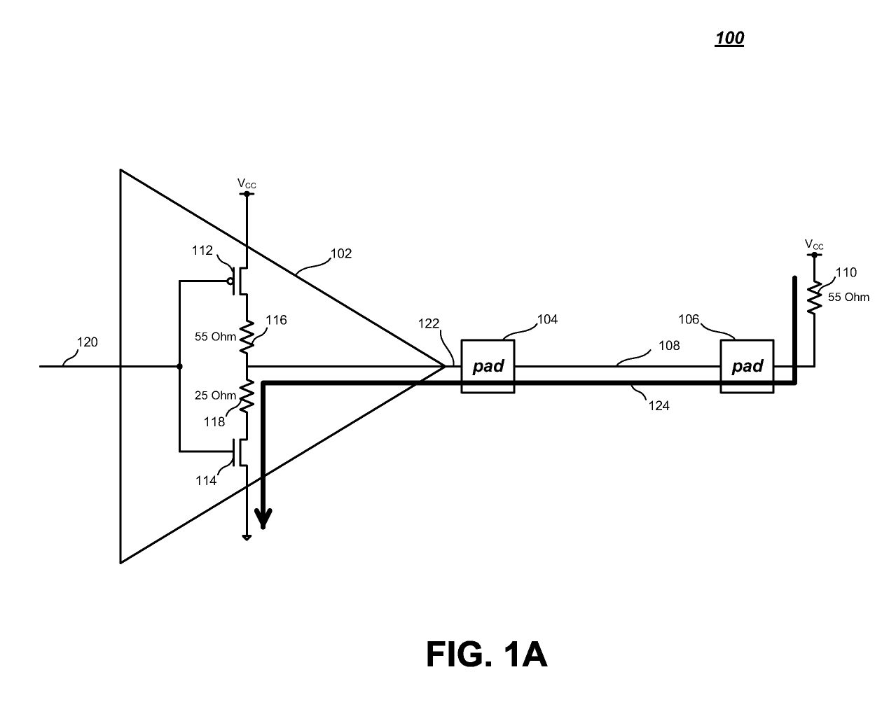

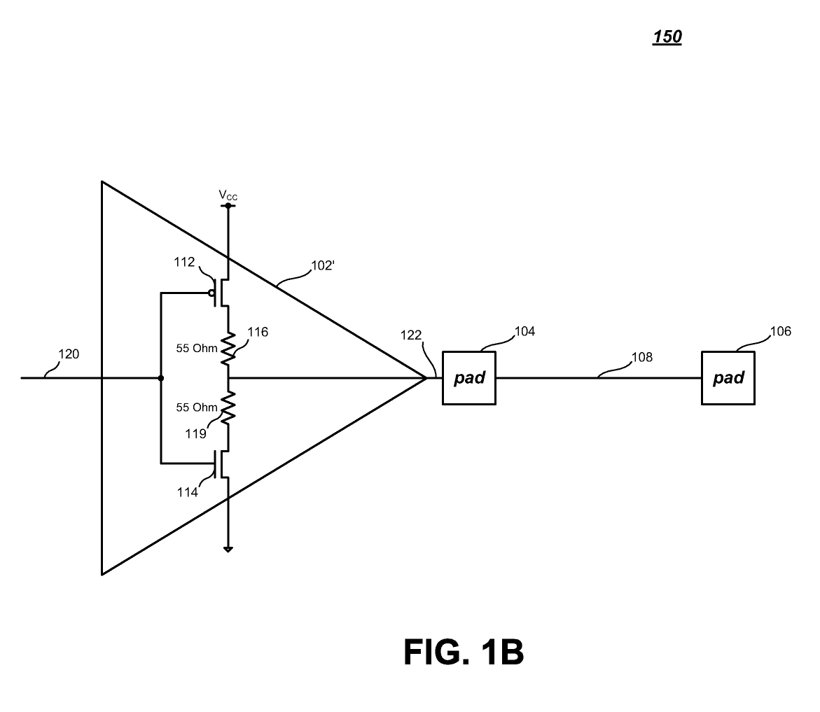

FIG. 1A illustrates one embodiment of an apparatus that may transfer signals across an interconnection medium. In particular, FIG. 1A shows an apparatus 100 comprising various elements. The embodiments, however, are not limited to these depicted elements. As shown in FIG. 1A, apparatus 100 may include a driver module 102, a first connection point or pad 104, a second connection point or pad 106, an interconnection medium 108, and a pull-up resistance 110.

FIG. 1A shows that driver module 102 includes a circuit comprising an P-Channel field effect transistor (FET) device 112, an N-channel FET device 114, a first resistance 116, and a second resistance 118 (also referred to as a pull-down resistance). As shown in FIG. 1A, resistance 116 may be approximately 55 Ohms and resistance 118 may be approximately 25 Ohms.

An input terminal 120 is coupled to the gate terminals of devices 112 and 114. Also, an output terminal 122 is coupled between resistances 116 and 118. Additionally output terminal 122 is coupled to interconnection medium 108 via pad 104.

Pads 104 and 106 provide connections (e.g., physical contact) to interconnection medium 108 for driver module 102 and pull-up resistance 110, respectively.

Interconnection medium 108 provides for the transfer of electrical signals. For instance, interconnection medium 108 may provide for driver module 102 to send a logical signal to a receiving circuit (not shown), which is coupled to pad 106. Accordingly, interconnection medium 108 may be a line within a bus interface, such as a computer system front side bus (FSB) or processor bus. Additionally, interconnection medium 108 may have a characteristic impedance that is substantially equal to pull-up resistance 110 (e.g., approximately 55 Ohms). The embodiments, however, are not limited as such.

Driver module 102 may drive interconnection medium 108 with an output signal, which it provides at output terminal 122. This output signal may be a digital logic signal, such as a binary signal. For instance, driver module 102 may provide output terminal 122 with a high voltage level (corresponding, for example, to a logical ‘1’) or a low voltage level (corresponding, for example, to a logical ‘0’).

As shown in FIG. 1A, when driver module 102 drives interconnection medium 108 with a low voltage level, an electrical current 124 is drawn across interconnection medium 108. As a result, resistances 110 and 118 each dissipate power.

Signals transferred across interconnection medium 108 may employ GTL signaling. GTL provides for signals between 0.4 volts and 1.2 volts. In addition, GTL signaling protocols establish various requirements. One exemplary requirement mandates the employment of pull-up resistors (such as pull-up resistance 110) at every connected agent device. Such pull-up resistors are typically on the order of 50 to 100 ohms. Also, GTL signals employ voltage levels that may vary around approximately 1 volt (e.g., between 0.4 and 1.2 volts). As a result, a GTL signal that is pulled down every bus clock cycle may consume approximately 10 to 20 milliwatts of system power per non-driving connection.

Such requirements are directed at providing very clean signaling on an interface that is operating over a relatively large distance (e.g., approximately one foot in length) and is approaching the interface's maximum plausible signal frequencies, given its technology generation. However, in many devices, providing clean signaling at such large distances requirements can be excessive.

For example, in very small devices like laptop, notebook, and ultra-mobile personal computers (PCs), trace lengths for processor bus signals are often short. More particularly, such trace signals are often short in relationship to the period of the signal employed by the signaling protocol (e.g., GTL). Thus, employment of pull-up resistors may not be needed, since the flight times of the signals will be substantially reduced.

FIG. 1B shows a further embodiment of an apparatus that may transfer signals across an interconnection medium. In particular, FIG. 1B shows an apparatus 150, which is similar to apparatus 100 of FIG. 1A. However, apparatus 150 replaces driver module 102 with a driver module 102′. In addition, apparatus 150 does not include pull-up resistance 110.

Driver module 102′ is similar to driver module 102. However, as shown in FIG. 1B, resistance 118 is replaced with a resistance 119. This resistance (also referred to as a pull-down resistance) is shown having a higher value (55 Ohms instead of 25 Ohms). This different resistance value may be selected to match the characteristic impedance of interconnection medium 108.

Removing pull-up resistance 110, establishes driver module 102′ with an connection to interconnection medium 108 that is not terminated. This removes the DC current path associated with electrical current 124 of FIG. 1 while still maintaining acceptable signal integrity characteristics when the length of interconnection medium 108 is not excessive. Further, resistance 119, which is impedance-matched to interconnection medium 108, helps the quality of signals generated by driver module 102′.

Thus, by removing pull-up resistance 110, power consumption is reduced when driver module 102′ drives interconnection medium with a low voltage level (e.g., a logical ‘0’).

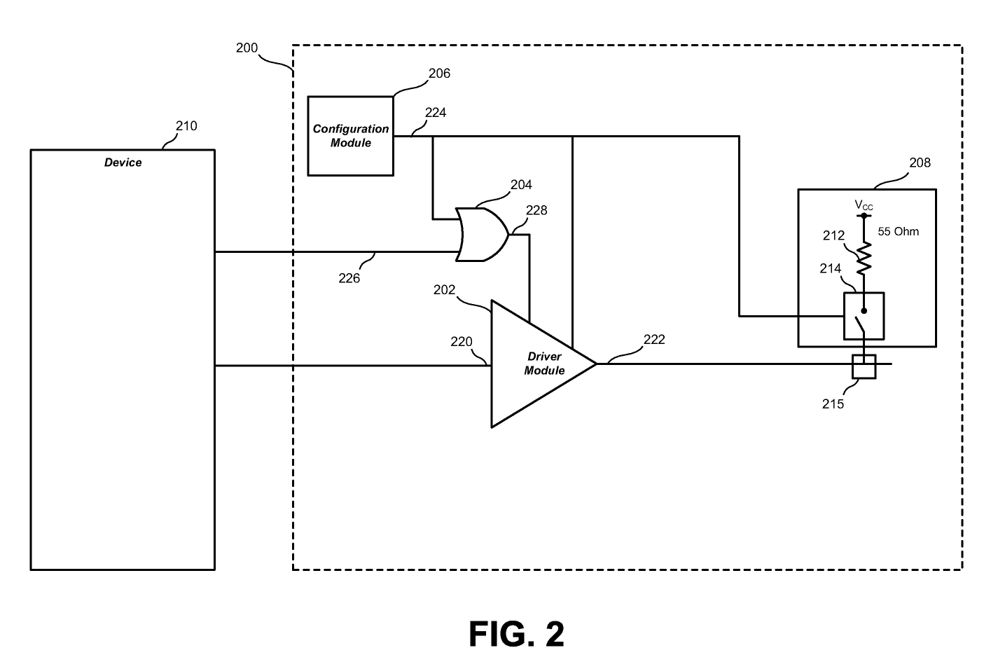

FIG. 2 is a diagram of an apparatus 200 that may be employed in driving signals across an interconnection medium.

Apparatus 200 may include various elements. For instance, FIG. 2 shows implementation 200 including a driver module 202, a logic gate 204, a configuration module 206, and a termination module 208. In addition, FIG. 2 shows a device 210. These elements may be implemented in hardware, software, firmware, or any combination thereof.

Driver module 202 may drive an interconnection medium 222. As shown in FIG. 2, interconnection medium 222 is coupled to termination module 208 at a termination point (e.g., a pad) 215. Driver module 202 and termination module 208 may selectively operate according to at least two different modes.

A first mode involves operating as described above with reference to FIG. 1A. More particularly, driver module 202 drives signals across interconnection medium 222 to termination module 208, which provides a pull-up resistance 212 that is coupled to interconnection medium 222.

A second mode involves operating as described above with reference to FIG. 1B. For instance, driver module 202 (when operating in the second mode) provides a pull-down resistance that is impedance matched to interconnection medium 222. Also, when operating in the second mode, termination module 208 does not couple pull-up resistance 212 to interconnection medium 222.

Moreover, when operating in the second mode, driver module 202 may only drive interconnection medium 222 when an input signal (or a particular type of input signal) is being applied to it at an input terminal 220. Otherwise, driver module 202 may be isolated (or substantially isolated through, for example, a high impedance) from interconnection medium 222.

In embodiments, driver module 202 may drive interconnection only when it receives a data signal or an address signal at input terminal 220. As shown in FIG. 2, such input signals may be received from device 210.

Thus, driver module 202 and termination module 208 may be implemented to provide for two or more modes of operation. Accordingly, driver module 202 may comprise two circuit implementations, such as an implementation of driver module 102 of FIG. 1A and an implementation of driver module 102′ of FIG. 1B. These implementations may be switchably coupled to interconnection medium 222 and input terminal 220 based on the employed mode of operation.

Alternatively, driver module 202 may comprise a circuit implementation having reconfigurable or adjustable elements. For example, driver module 202 may have a variable pull down resistance, or two or more pull-down resistance elements that may be configured in different ways. Moreover, driver module 202 may comprise element(s) to selectively isolate it from interconnection medium 222 so that it only drives interconnection medium 222 during second mode operations.

As described above, termination module 208 may provide a pull-up resistance in the first mode of operation, but not in the second mode of operation. Accordingly, FIG. 2 shows termination module 208 having a switching element 214, which may selectively couple pull-up resistance 212 to interconnection medium 222.

Such arrangements and implementations for driver module 202 and termination module 208 may be implemented with various solid-state switching techniques, logic gates, and/or other circuitry.

Interconnection medium 222 provides for the transfer of electrical signals among two or more devices. Accordingly, interconnection medium 222 may be a line within a bus interface, such as a computer system front side bus (FSB) or processor bus. The embodiments, however, are not limited to such.

As described above, device 210 may provide driver module 202 and configuration module 206 with various signals. Accordingly, device 210 may be, for example, a microprocessor or a central processing unit (CPU). However, device 210 may be other devices. Examples of such devices include microcontrollers, application specific integrated circuits (ASICs), memory devices, and so forth. The embodiments are not limited to such examples.

Operation according to the aforementioned operational modes may be determined by configuration module 206 and logic gate 204. Configuration module 206 establishes a setting, which determines a particular operational mode for driver module 202 and/or termination module 208. For instance, with reference to the first and second modes described herein, configuration module 206 may establish whether operations may be according to the first mode or the second mode.

This established setting is represented by configuration signal 224, which is sent to driver module 202 and termination module 208. Based on this signal, driver module 208 and termination module 208 are configured for operation according to the determined operational mode.

Logic gate 204 is shown as an OR gate that receives configuration signal 224 as an input. Also, logic gate 204 receives an active signal 226. As shown in FIG. 2, this signal may be received from device 210. Active signal 226 indicates whether a signal (or a signal of a certain type such as a data or address signal) is currently being provided to input terminal 220.

As described above, configuration signal 224 may establish performance according to a particular operational mode. For example, a logical “0” may indicate second mode operations and a logical “1” may indicate first mode operations. However, the embodiments are not limited to this convention. Also, as described above, active signal 226 indicates whether a signal (or a signal of a certain type) is currently being provided to input terminal 220.

Thus, logic gate 204 may output a drive signal 228, which directs driver module 202 to drive interconnection medium 222. This may occur during first mode operations, or during second mode operations when active signal 226 indicates that a signal is being provided to input terminal 220. In embodiments, driver module 202 may drive interconnection medium 222 when drive signal 228 is a logical “1” and not drive interconnection medium “0” when drive signal 228 is a logical “0”.

Configuration module 206 may establish the operational mode during operation of apparatus 200. This may be based on various factors. Examples of such factors include available power, device clock frequency, bus cycle frequency, and/or user selection. Accordingly, configuration module 206 may be implemented with hardware, software, firmware, or a combination thereof.

Alternatively, the setting provided by configuration module 206 may be preconfigured before operation. Preconfiguration techniques may include hardwiring, setting switches or jumpers, configuring memory (e.g., read only memory) and so forth. The embodiment, however, are not limited to these examples. Accordingly, in cases where such preconfiguration occurs, configuration module 206 may generate configuration signal 224 such that it has a constant value.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented, unless otherwise indicated. In addition, the given logic flow may be implemented by a hardware element, a software element executed by a processor, or any combination thereof. The embodiments are not limited in this context.

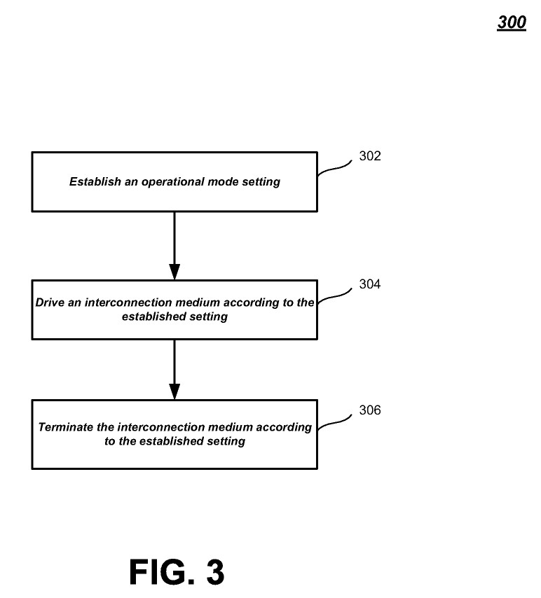

FIG. 3 illustrates one embodiment of a logic flow. In particular, FIG. 3 illustrates a logic flow 300, which may be representative of the operations executed by one or more embodiments described herein. As shown in logic flow 300, a block 302 establishes an operational mode setting. This setting may be from two or more operational modes. For example, the setting may be from the first and second operational modes described above with reference to FIG. 2.

A block 304 drives an interconnection medium (e.g., interconnection medium 222) according to the operational mode setting established by block 302. For the first operational mode, this may involve continually driving the interconnection medium. However, for the second operational mode, this may involve driving the interconnection medium only upon receiving an input signal (e.g., a data or address signal). Further, in the second operational mode, an impedance matched pull-down resistance may be coupled to the interconnection medium. In the context of FIG. 2, block 304 may be implemented with driver module 202.

A block 306 terminates the interconnection medium in accordance with the operational mode setting. For the first operational mode, this may involve coupling a pull-up resistance to the interconnection medium at a termination point. However, for the second operational mode, this may involve isolating the pull-up resistance from the interconnection medium. With reference to FIG. 2, block 306 may be implemented with termination module 208.

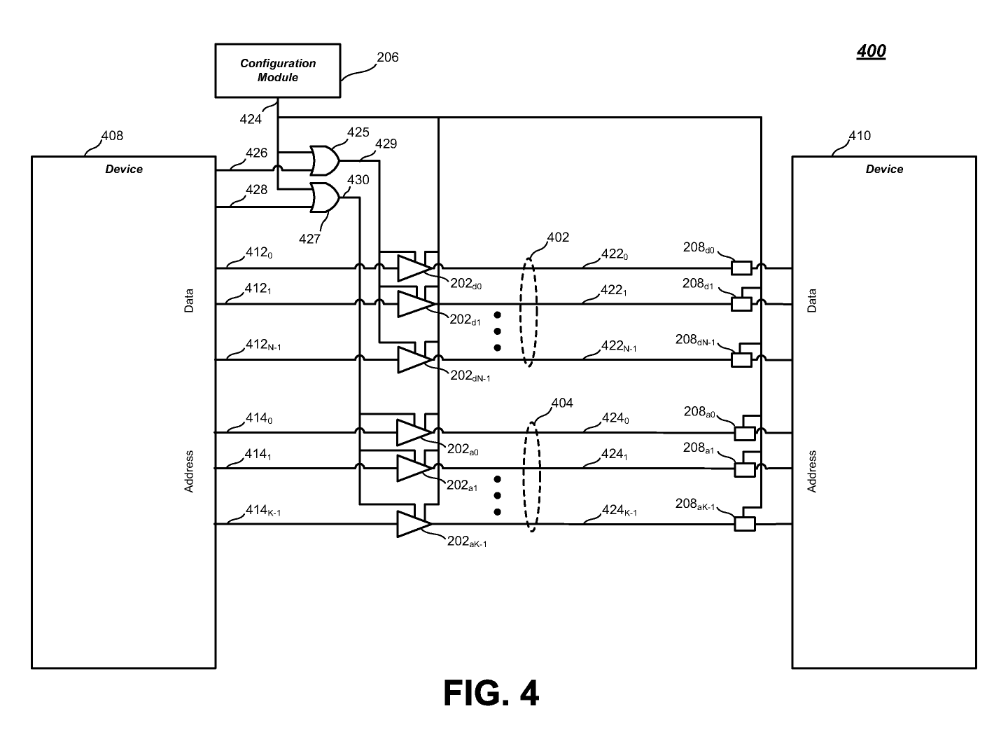

FIG. 4 is a diagram of an exemplary system embodiment. In particular, FIG. 4 is a diagram showing a system 400, which may include various elements. For instance, FIG. 4 shows that system 400 may include a bus interface 402, a bus interface 404, a device 408, a device 410, a configuration module 206, a logic gate 425 and a logic gate 427. These elements may be implemented in hardware, software, firmware, or any combination thereof.

Bus interfaces 402 and 404 may each include multiple signal lines. For instance, FIG. 4 shows bus interface 402 having N data signal lines (422₀-422_{N-1}). Similarly, FIG. 4 shows bus interface 404 having K signal lines (424₀-424_{K-1}). Bus interfaces 402 and 404 provide connectivity between devices 408 and 410. The embodiments, however, are not limited as such. For instance, bus interfaces 402 and 404 may provide connectivity among various numbers of devices. Thus, these bus interfaces may be employed in various contexts. For example, bus interfaces 402 and 404 may be employed in a front side bus (FSB) or computer bus. An FSB bus may provide for bi-directional communication of information between a central processing unit (CPU) and other devices. Examples of other devices include random access memory (RAM), video cards, PCI expansion cards, hard disks, read only memory, and so forth.

FIG. 4 shows that device 408 is connected to bus interfaces 402 and 404 by driver modules 202. Also, FIG. 4 shows that device 410 is connected to bus interfaces 402 and 404 by termination modules 208. As described herein, driver modules 202 and termination modules 208 provide for the exchange of signals across interconnection media (e.g., bus interfaces 402 and 404) in accordance with various operational modes, such as the first and second modes described above with reference to FIG. 2.

As shown in FIG. 4, configuration module 206 generates a configuration signal 424, which is sent to each driver module 202 and each termination module 208. Additionally, FIG. 4 shows device 408 generating a data active signal 426 and an address active signal 428. Data active signal 426 indicates that device 408 is providing data signals on lines 412. Similarly, address active signal 428 indicates that device 408 is providing data signals on lines 414. Although FIG. 4 shows lines 412 being separate from lines 414, some or all of these lines may be shared through techniques, such as multiplexing.

Data active signal 426 and address active signal 428 are sent to logic gates 425 and 427, respectively. Logic gates 425 and 427 also receive configuration signal 424. From these inputs, logic gates 425 and 427 generate drive signals 429 and 430 in the manner described above with reference to FIG. 2.

FIG. 4 further shows that drive signal 429 is sent to driver modules 202_{d0}-202_{dN-1}, while drive signal 430 is sent to driver modules 202ₐ₀-202_{aK-1}. Based on these signals (as well as on configuration signal 424), driver modules 202_{d0}-202_{dN-1} and 202ₐ₀-202_{aK-1} may operate according to the modes described herein. However, termination modules 208 may operate based on configuration signal 424 without receiving drive signals 429 and 430.

For purposes of clarity, FIG. 4 shows driver modules 202 provided to device 408, and termination modules 208 provided to device 410. However, devices 408 and 410 may each be provided with driver modules 202 and terminations modules 208 to provide bidirectional communications capabilities.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a configuration module to establish an operational mode setting from a first operational mode and a second operation mode; and
a driver module;
wherein, when the first operational mode is established, the driver module is to continually drive an interconnection medium; and
wherein, when the second operational mode is established, the driver module is to drive the interconnection medium upon receiving an input signal and to otherwise refrain from driving the interconnection medium.

2. The apparatus of claim 1, further comprising a termination module having a pull-up resistance;
wherein the pull-up resistance is to be coupled to the interconnection medium when the first operational mode is established; and
wherein the pull-up resistance is to be isolated from the interconnection medium when the second operational mode is established.

3. The apparatus of claim 1, wherein the driver module includes a pull-down resistance to be coupled to interconnection medium, wherein the pull-down resistance is impedance matched to the interconnection medium when the second operational mode is established.

4. The apparatus of claim 1, wherein the input signal is an address signal or a data signal.

5. The apparatus of claim 1, further comprising the interconnection medium.

6. The apparatus of claim 1, wherein the interconnection medium is included in a bus interface.

7. The apparatus of claim 1, wherein when the first operational mode is established, the driver module is to continually drive the interconnection medium according to a gunning transceiver logic (GTL) signaling protocol.

8. The apparatus of claim 2, wherein when the first operational mode is established, the termination mode is to operate according to a gunning transceiver logic (GTL) signaling protocol.

9. The apparatus of claim 1, wherein the driver module is to receive a drive signal, the drive signal indicating whether to drive the interconnection medium.

10. The apparatus of claim 1, wherein the driver module is to receive a configuration signal from the configuration module, the configuration signal indicating the established operational mode.

11. The apparatus of claim 2, wherein the termination module is to receive a configuration signal from the configuration module, the configuration signal indicating the established operational mode.

12. A method, comprising:
establishing one of a first operational mode and a second operation mode as an operational mode setting;
continually driving an interconnection medium when the first operational mode is established; and
driving the interconnection medium only upon receiving an input signal when the second operational mode is established.

13. The method of claim 12, further comprising:
coupling a pull-up resistance to the interconnection medium at a termination point only when the first operational mode is established; and
otherwise isolating the pull-up resistance from the interconnection medium.

14. The method of claim 12, further comprising:
continually driving the interconnection medium according to a gunning transceiver logic (GTL) signaling protocol when the first operational mode is established.

15. The method of claim 12, wherein the input signal is an address signal or a data signal.

16. The method of claim 12, wherein the interconnection medium is included in a bus interface.

17. A system, comprising:
a bus interface having a plurality of signal lines;
a configuration module to establish an operational mode setting from one of a first operational mode and a second operation mode; and
for each of the signal lines, a driver module;
wherein, when the first operational mode is established, the driver module is to continually drive its corresponding signal line; and
wherein, when the second operational mode is established, the driver module is to drive its corresponding signal line upon receiving an input signal and to otherwise refrain from driving the interconnection medium.

18. The system of claim 17, further comprising:
for each of the signal lines, a termination module having a pull-up resistance;
wherein the pull-up resistance is to be coupled to its corresponding signal line when the first operational mode is established; and
wherein the pull-up resistance is to be isolated from its corresponding signal line when the second operational mode is established.

19. The system of claim 17, wherein the plurality of signal lines include multiple data lines, multiple address lines, and multiple control lines;

20. The system of claim 17, further comprising a central processing unit (CPU) coupled to the driver modules.
